(19) United States
(12) Patent Application Publication
(10) Pub. No.: US 2011/0091839 A1
(43) Pub. Date: Apr. 21, 2011

(54) PROFILE BODY FOR DENTAL CLEANING

(75) Inventors: Meike Niesten, Koeln (DE); Steffen Hofacker, Odenthal (DE); Thorsten Rische, Columbus, GA (US); Sebastian Doerr, Duesseldorf (DE)

(73) Assignee: Bayer Material Science AG, Leverkusen (DE)

(21) Appl. No.: 13/000,047

(22) PCT Filed: Jun. 6, 2009
(86) PCT No.: PCT/EP2009/004082

§ 371 Date: Dec. 20, 2010

(30) Foreign Application Priority Data
Jun. 20, 2008 (EP) 08158679.4

(51) Int. Cl. A61C 17/00; B29C 44/56

(52) U.S. Cl. 433/216; 264/48

(57) ABSTRACT

The present invention relates to a strand-like profile body for dental cleaning, wherein the cross-section of the profile body comprises a bottom section (10) and first wall sections (12) and second wall sections (14), which adjoin the bottom section and are arranged opposite of each other, and wherein furthermore the bottom section (10) together with the first and second wall sections (12, 14) forms at least one recess (16, 18) in the profile body for receiving a tooth. The invention further relates to a method for the production thereof and the use thereof for cleaning teeth.

The present invention relates to a strand-like profile body for tooth cleaning with a particular design. It furthermore relates to a process for the production thereof and also use thereof for the cleaning of teeth.

On account of the increasing need of society for oral care for the periods between meals or following consumption of a between-meal snack or other products consumed for pleasure such as sweets, nicotine, alcohol, or else on account of increased mobility (air or rail travel) in which conventional tooth cleaning with water, toothpaste and toothbrush is not possible, in the past products such as dental care chewing gums and also dental care wipes have been developed.

Dental care chewing gums consist essentially of so-called chewing gum base. This in turn consists of natural or synthetic polymers such as, for example, latex, polyvinyl ether, polyisobutylene vinyl ether or polyisobutene. Dental care chewing gums of this type generally comprise, as dental care agents, pH-controlling substances which thus counteract the development of tooth decay (caries). On account of their plastic behaviour, such dental care chewing gums, however, barely contribute to cleaning the chewing surfaces or tooth sides. In addition, chewing gums generally have the disadvantage that, on account of their sticking properties, they often have to be mechanically removed from the floor of public streets and areas, and be disposed of, which means considerable cleaning expenditure.

Dental care wipes (for example Oral-B Brush Aways™, Gillette GmbH & Co. OGH, Germany) are characterized in that they achieve a good cleaning effect of the tooth sides by attaching the dental care wipe to a finger and by rubbing the teeth. However, the mode of using such dental cleaning wipes in public is not very accepted for aesthetic reasons and is thus no alternative to using a conventional toothbrush.

U.S. Pat. No. 4,149,815 discloses a chewable tooth cleaning device. This comprises 2.45 to 9.0 cm³ of an essentially closed-cell compressible polymer foam with an essentially skin-free surface. The device is designed to clean exposed tooth surfaces. In particular, the polymer foam has about 12 to 50 cells per linear centimetre, a water absorption of less than 1.0 mg/cm³ after immersion in water for 24 hours, a tensile strength of at least 3.4×10⁵ Pa, a pressure resistance of at least 5.5×10⁴ Pa at 10% deflection and at least 8.3×10⁴ Pa at 25% deflection, a tear strength of at least 1.38×10⁵ Pa and is sufficiently elastic in order to occupy at least 90% of the uncompressed height almost directly after compression to 10% of the uncompressed height again.

NL 7810061 discloses an oral hygiene device which is also referred to commercially as dental care wheel.

U.S. 2002/0106234 A1 discloses a chewable tooth cleaning device. This chewable toothbrush is made of a flexible shell, a plurality of bristles coupled to the shell, which essentially protrude from the exterior of the shell, and furthermore a chewable centre within the shell and a burstable capsule adjacent to the chewable centre within the shell interior.

U.S. 2005/0260027 A1 discloses a disposable or edible chewable toothbrush for cleaning teeth between meals. The device includes a chewable bristle holder with bristles attached to the holder, a cavity in the holder, a substance in the cavity, and weak regions in the holder which prevent the contents of the holder from escaping until the holder is compressed by chewing. In a further embodiment, a disposable or edible brush is housed within a disposable or edible shell. Upon chewing, the shell is broken or dissolves and releases its contents, which includes the brush and possibly a dentifrice.

A disadvantage of the described tooth cleaning devices is that they exhibit an unsatisfactory cleaning effect on the tooth sides or in the depressions in the chewing surfaces. Their production is also sometimes complex.

WO 2007/121866 A1 discloses novel chewing masses for the oral care sector based on polyurethane-polyureas, a production process, and their use.

WO 2007/121867 A1 discloses novel chewing masses for the oral care sector based on foamed synthetic polymers, a production process, and its use.

Tooth cleaning devices would be desirable which, on account of their design, have an improved cleaning effect on the tooth sides, on depressions in the chewing surfaces or on depressions in the tooth sides, as occur in the transition between tooth side and gum. In order to achieve this, the tooth cleaning device needs a specific shape and should be produced from a soft foam which is dimensionally stable during chewing. Furthermore, it would be desirable if the design were also to emphasize a pleasant mouth feel.

Proposed according to the invention is therefore a strand-like profile body for tooth cleaning, where the cross section of the profile body encompasses a floor section and first wall sections and second wall sections which adjoin the floor section and are arranged opposite one another, where in the cross section the maximum expanse of the profile body in the direction of the first and second wall section defines the height of the profile body, where in the cross section the maximum expanse of the profile body perpendicular to the height defines the width of the profile body and where furthermore the floor section together with the first and second wall section forms at least one gap in the profile body to accommodate a tooth.

The strand-like profile body according to the invention is preferably configured in one piece. However, it is likewise possible for the profile body to comprise a plurality of material layers.

Within the context of the present invention, a strand-like profile body is to be understood in particular as meaning a body whose cross sectional form, when seen along a spatial axis, does not change or changes only within the scope of the technically unavoidable tolerances.

Since the cross section shape, when seen along a spatial axis, does not change or changes only insignificantly, the cross section profile can be used to describe the shape of the body; this is a sectional plane perpendicular to the aforementioned axis and where the observer looks onto the profile body along the aforementioned axis.

The profile body according to the invention comprises, when seen in cross section, a floor section and two wall sections arranged opposite one another. The floor section thus joins the two wall sections together. In the simplest form, the profile body, when seen in cross section, is U-shaped or H-shaped. The floor is present in the profile body as its own section and is not merely the cutting point between two wall sections.

As a result of the fact that an actual floor section is provided, the sides of the wall sections facing the gap can form a relatively small angle relative to the middle axis of the cross section profile and there always still remains enough space on the floor of the profile body for the tooth to be accommodated. The middle axis here is the axis which also proceeds in the direction of the expanse of the first and second wall section. The angle of the sides of the wall sections or, if the wall sections are irregularly structured, the angle of a straight line which tangentially touches the uppermost and the lowermost elevation of the wall section on the side facing the gap, can be, for example, in a range from ≧5° to ≦30° or from ≧10° to ≦20°.

The first and second wall sections are preferably designed such that their edge opposite the gap is curved outwardly, i.e. away from the gap.

The height of the cross section of the profile body arises from its maximum expanse in the direction of the wall sections, i.e. parallel to the wall sections. In other words, the height of the cross section is determined by the length of the wall sections. Perpendicular to this, the width is defined in the cross section. In other words, the width of the cross section is determined from the distance of the wall sections relative to one another.

According to the invention, it is envisaged that the profile body forms at least one gap to accommodate a tooth. This gap, seen in cross section, is limited by the floor section and by the two wall sections. In the case of a generally U-shaped profile, one gap is present; in the case of a generally H-shaped profile, two gaps are present.

Upon chewing, one tooth or else a plurality of teeth can then enter the gap. In this way, the tooth is contacted both by the floor section and also by the two wall sections of the profile body. As a result of this, an improved cleaning effect is achieved.

In one advantageous embodiment, the profile body can also be envisaged as a specially shaped chewing foam. In this connection, the term “chewing foam” means materials with a foam structure which are suitable, by chewing same in the mouth, for achieving a cleaning of the tooth surfaces and tooth sides, where the foam material is elastic and reverts to its original shape after each chewing process. Preference is given to foams with a high degree of open-cell content.

Preferably, the material of the profile body comprises synthetic polymers. Of suitability as such are, in principle, all synthetic or chemically modified natural polymeric materials which can be foamed, if necessary with the aid of propellant gases or mechanical energy. In this connection, it may be advantageous if foam auxiliaries are added in order to obtain a stable foam structure.

Such foamable synthetic polymers may be polyurethane flexible foams obtainable from one or more (poly)isocyanates and one or more polyol components, but also on the basis of thermoplastic polyurethanes or based on aqueous polyurethane dispersions. Preference is given to open-cell foams based on aqueous polyurethane dispersions on account of their excellent ability to regain their shape during chewing (dimensional stability) and their fine pores, which results in a pleasant feel in the mouth.

In order to be able to foam the synthetic polymers, these are preferably firstly provided as liquid phase. If the constituents of the foams are not per se present as liquid, this can take place by dissolving or dispersing non-liquid constituents in a liquid component. Likewise possible in this regard is the use of organic solvents, plasticizers, water or melting in order to provide the constituents in a phase liquid under foaming conditions, for example as solution, dispersion or melt.

The actual foaming takes place by introducing air, nitrogen gas, low-boiling liquids such as pentane, fluorocarbons, methylene chloride or by a chemical reaction such as the release of CO₂ by chemical reaction of isocyanate with water.

Curing to give the foam structure can start even during foaming. This is the case, for example, when using isocyanate/polyol mixtures to form the synthetic polymer.

Curing after foam formation takes place, for example, with the use of aqueous polyurethane dispersions, which are firstly foamed and only then dried for the curing.

Besides chemical crosslinking or physical drying, curing can also take place through temperature reduction of a melt, gelation of plastisols or coagulation, for example of latices.

“Curing to give the foam structure” means here that the foamed mixture is converted to the solid state such that collapse of the foam with loss of the cell structure of the foam does not result. In this connection, foams are then obtained which have advantageous foam densities.

Curing by physical drying preferably takes place at a temperature of 25° C. to 150° C., preferably 30° C. to 145° C., particularly preferably at 60° C. to 145° C. The drying can take place in a conventional drier. Drying in a microwave (HF) drier is likewise possible.

In one embodiment of the profile body, when seen in cross section, the floor section of the profile body forms elevations on its side facing a gap. As a result of such elevations, depressions in the chewing surfaces of the teeth which are accommodated in the gap can be better reached.

The elevations can here and also generally within the context of the present invention also be referred to as bulges. Corresponding to this are depressions or indentations.

In a further embodiment of the profile body, when seen in cross section, the floor section of the profile body forms elevations on its side opposite to a gap. As a result of such elevations, depressions in the chewing surfaces of the teeth which are located on the side of the profile body opposite the gap can be better reached.

In a further embodiment of the profile body, when seen in cross section, the first wall section and/or the second wall section of the profile body forms elevations on its side facing a gap. In this way, depressions on the tooth flanks, for example at the transition between tooth and gum, are better reached. The elevations can also be referred to as bulges.

In a further embodiment of the profile body, when seen in cross section, the number of elevations is in a range from ≧2 to ≦10. These are to be understood as meaning both the elevations on both sides of the floor section and also elevations on the wall sections. For example, the floor section can have two elevations on its side facing the gap, ≧4 to ≦6 elevations on its side opposite the gap, and the first and second wall sections in each case have ≧4 to ≦6 elevations on their side facing the gap.

In a further embodiment of the profile body, when seen in cross section, the height of the elevations, measured as the distance of the deepest point between two elevations at a right angle to the joining line between two highest points of the elevations directly adjacent to the deepest point, relative to the height of the profile body is in a ratio of from ≧1:15 to ≦1:5. This ratio advantageously relates to the elevations of the floor section at both sides of the gap. This height ratio is tailored such that, for a profile body which can be used as intended for tooth cleaning, the elevations fit well into depressions in the chewing surfaces and thus an improved cleaning effect can be achieved. The height ratio can also be in a range from ≧1:10 to ≦1:6 or from ≧1:8 to ≦1:7.

In a further embodiment of the profile body, when seen in cross section, the height of the elevations, measured as distance of the deepest point between two elevations at a right angle to the joining line between two highest points of the elevations directly adjacent to the deepest point, relative to the height of the profile body is in a ratio of from ≧1:30 to ≦1:10. Advantageously, this height ratio relates to the gaps of the first and second wall sections on their side facing the gap. This height ratio is tailored such that, for a profile body which can be used as intended for tooth cleaning, the elevations fit well into depressions on the tooth flanks and thus an improved cleaning effect can be achieved. The height ratio can also be in a range from ≧1:25 to ≦1:15 or from ≧1:20 to ≦1:17.

In a further embodiment of the profile body, when seen in cross section, the maximum expanse of the floor section to the width of the profile body is in a ratio of from ≧1:6 to ≦1:2. This width ratio is advantageous so that also wide back teeth can reach the floor of the gap and thus the chewing surfaces can be cleaned. The width ratio can also be in a range from ≧1:3 to ≦1:2 or from ≧1:2.8 to ≦1:2.4.

In a further embodiment of the profile body, when seen in cross section, the distance of the deepest point on the side of the floor section facing the gap perpendicular to the joining line between the highest points of the first and second wall section relative to the height of the profile body is in a ratio of from ≧1:4 to ≦1:1.5. This thus states how deep the gap for accommodating a tooth is relative to the total height of the profile body. The ratio can also be in a range from ≧1:3 to ≦1:1.7 or from ≧1:2 to ≦1:1.8. Ratios in these ranges allow the tip of the tooth to reach the floor section without the gum being painfully pressed away by too strongly compressed material in the upper area of the profile body.

In a further embodiment of the profile body, the material of the profile body comprises a polymer foam with a tensile modulus at 100% extension of ≧0.3 MPa to ≦3.5 MPa, a tensile strength of ≧0.5 MPa to ≦40 MPa and an extensibility of ≧100% to ≦2000%. The tensile moduli can be ascertained in accordance with DIN EN ISO 527. The tensile experiments can be carried out by reference to DIN 53504 using a dumbbell S2 sample body. The tensile modulus at 100% extension can also be in a range from ≧0.4 MPa to ≦3 MPa or from ≧1 MPa to ≦2 MPa. The tensile strength can also be in a range from ≧1 MPa to ≦30 MPa or from ≧5 MPa to ≦20 MPa. The extensibility can also be in a range from ≧200% to ≦1800% or from ≧500% to ≦1500%. Using such material properties, the profile bodies can withstand the mechanical stresses which prevail during chewing in the human dentition.

In a further embodiment of the profile body, the polymer is obtainable from a polyurethane-polyurea dispersion (I) which in turn is obtainable by preparing
A) isocyanate-functional prepolymers of
   a1) organic polyisocyanates
   a2) polymeric polyols with number-average molecular weights of ≧400 g/mol to ≦8000 g/mol and OH functionalities of ≧1.5 to ≦6,
B) whose free NCO groups are then completely or partially reacted with
   b1) amino-functional compounds with molecular weights of ≧32 g/mol to ≦400 g/mol and/or
   b2) amino-functional, ionic or potentially ionic hydrophilizing agents
      with chain extension, and the prepolymers are dispersed in water before, during or after step B), where any potentially ionic groups can be converted to the ionic form by partial or complete reaction with a neutralizing agent.

Advantageously, in step A), the isocyanate-functional prepolymers are furthermore prepared from
a3) hydroxy-functional compounds with molecular weights of ≧62 g/mol to ≦399 g/mol and/or
a4) hydroxy-functional, ionic or potentially ionic and/or nonionic hydrophilizing agents.

Isocyanate-reactive groups are, for example, amino, hydroxy or thiol groups.

Examples of such organic polyisocyanates which can be used in component a1) are 1,4-butylene diisocyanate, 1,6-hexamethylene diisocyanate (HDI), isophorone diisocyanate (IPDI), 2,2,4 and/or 2,4,4-trimethylhexamethylene diisocyanate, the isomeric bis(4,4′-isocyanatocyclohexyl)methanes or mixtures thereof of any desired isomer content, 1,4-cyclohexylene diisocyanate, 1,4-phenylene diisocyanate, 2,4- and/or 2,6-toluylene diisocyanate, 1,5-naphthylene diisocyanate, 2,2′- and/or 2,4′- and/or 4,4′-diphenylmethane diisocyanate, 1,3- and/or 1,4-bis(2-isocyanatoprop-2-yl)benzene (TMXDI), 1,3-bis(isocyanatomethyl)benzene (XDI), (S)-alkyl 2,6-diisocyanatohexanoates, (L)-alkyl 2,6-diisocyanatohexanoates, with branched, cyclic or acyclic alkyl groups having up to 8 carbon atoms.

Besides the aforementioned polyisocyanates, modified diisocyanates with uretdione, isocyanurate, urethane, allophanate, biuret, iminooxadiazinedione and/or oxadiazinetrione structure and also non-modified polyisocyanate with more than two NCO groups per molecule, for example 4-isocyanatomethyl 1,8-octane diisocyanate (nonane triisocyanate) or triphenylmethane 4,4′,4″-triisocyanate, can also be co-used, proportionately.

These are preferably polyisocyanates or polyisocyanate mixtures of the type specified above with exclusively aliphatically and/or cycloaliphatically bonded isocyanate groups and an average NCO functionality of the mixture of from 2 to 4, preferably 2 to 2.6 and particularly preferably 2 to 2.4.

Particularly preferably, in a1), 1,6-hexamethylene diisocyanate, isophorone diisocyanate, the isomeric bis(4,4′-isocyanatocyclohexyl)methanes, and mixtures thereof are used.

Preferably, in a2), polymeric polyols with number-average molecular weights of from 400 to 6000 g/mol, particularly preferably from 600 to 3000 g/mol, are used.

These preferably have OH functionalities of from 1.8 to 3, particularly preferably from 1.9 to 2.1.

Such polymeric polyols are, for example, polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols. In a2) these can be used individually or in any desired mixtures with one another.

Such polyester polyols are, for example, polycondensates of di- and optionally tri- and tetraols and di- and optionally tri- and tetracarboxylic acids or hydroxycarboxylic acids or lactones. Instead of the free carboxylic acids, it is also possible to use the corresponding polycarboxylic anhydrides or corresponding polycarboxylic acid esters of lower alcohols for producing the polyesters.

Examples of suitable diols are ethylene glycol, butylene glycol, diethylene glycol, triethylene glycol, polyalkylene glycols such as polyethylene glycol, also 1,2-propanediol, 1,3-propanediol, butanediol(1,3), butanediol(1,4), hexanediol(1,6) and isomers, neopentyl glycol or hydroxypivalic acid neopentyl glycol ester, where hexanediol(1,6) and isomers, neopentyl glycol and hydroxy-pivalic acid neopentyl glycol ester are preferred. In addition, it is also possible to use polyols such as trimethylolpropane, glycerol, erythritol, pentaerythritol, trimethylolbenzene or trishydroxyethyl isocyanurate.

Dicarboxylic acids which can be used are phthalic acid, isophthalic acid, terephthalic acid, tetrahydrophthalic acid, hexahydrophthalic acid, cyclohexanedicarboxylic acid, adipic acid, ezelaic acid, sebacic acid, glutaric acid, tetrachlorophthalic acid, maleic acid, fumaric acid, itaconic acid, malonic acid, suberic acid, 2-methylsuccinic acid, 3,3-diethyiglutaric acid and/or 2,2-dimethyl-succinic acid. The corresponding anhydrides can also be used as acid source.

If the average functionality of the polyol to be esterified is >2, monocarboxylic acids, such as benzoic acid and hexane carboxylic acid, can additionally also be co-used.

Preferred acids are aliphatic or aromatic acids of the type specified above. Particular preference is given to adipic acid, isophthalic acid and phthalic acid.

Hydroxycarboxylic acids which can be co-used as reaction participants in the production of a polyester polyol with terminal hydroxyl groups are, for example, hydroxycaproic acid, hydroxybutyric acid, hydroxydecanoic acid, hydroxystearic acid and the like. Suitable latones are caprolactone, butyrolactone and homologs. Preference is given to caprolactone.

In a2) it is likewise possible to use polycarbonates having hydroxyl groups, preferably polycarbonatediols with number-average molecular weights Mₙ of from 400 to 8000 g/mol, preferably 600 to 3000 g/mol. These are obtainable by reacting carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 3-methyl-1,5-pentanediol, 2,2,4-trimethylpentanediol-1,3, dipropylene glycol, polypropylene glycols, dibutylene glycol, polybutylene glycols, bisphenol A, tetrabromobisphenol A and lactone-modified diols of the type specified above. It is also possible to use mixtures of different diols.

Preferably, the diol component comprises 40 to 100% by weight of hexanediol, preference being given to 1,6-hexanediol and/or hexanediol derivatives. Such hexanediol derivatives are based on hexanediol and, besides terminal OH groups, have ester or ether groups. Such derivatives are obtainable by reacting hexanediol with excess caprolactone or by etherifying hexanediol with itself to give the di- or trihexylene glycol.

Instead of or in addition to pure polycarbonatediols, it is also possible to use, in a2), polyether-polycarbonatediols which also contain polyetherdiols besides the described diols as diol component.

Polycarbonates having hydroxyl groups are preferably linear in structure, but can also contain branches as a result of the incorporation of polyfunctional components, in particular low molecular weight polyols. Of suitability in this regard are, for example, glycerol, trimethylolpropane, hexanetriol-1,2,6, butanetriol-1,2,4, trimethylolpropane, trimethylolethane, pentaerythritol, quinitol, mannitol, sorbitol, methyl glycoside or 1,3,4,6-dianhydrohexitols.

Suitable polyether polyols are, for example, polytetramethylene glycol polyethers, as are obtainable through polymerization of tetrahydrofuran by means of cationic ring-opening.

Likewise suitable polyether polyols are the addition products of styrene oxide, ethylene oxide, propylene oxide, butylene oxides and/or epichlorohydrins onto di- or polyfunctional starter molecules.

Suitable starter molecules which can be used are all compounds known according to the prior art, such as, for example, water, butyl diglycol, glycerol, diethylene glycol, trimethylolpropane, propylene glycol, sorbitol, ethylenediamine, triethanolamine, 1,4-butanediol.

Particularly preferred embodiments of the polyurethane dispersions (I) comprise, as component a2), a mixture of polycarbonate polyols and polytetramethylene glycol polyols. The fraction of the polycarbonate polyols in the mixture is 20 to 80% by weight and 80 to 20% by weight of polytetramethylene glycol polyols. A fraction of from 30 to 75% by weight of polytetramethylene glycol polyols and 25 to 70% by weight of polycarbonate polyols is preferred. Particular preference is given to a fraction of from 35 to 70% by weight of polytetramethylene glycol polyols and 30 to 65% by weight of polycarbonate polyols, in each case with the proviso that the sum of the percentages by weight of the polycarbonate and polytetramethylene glycol polyols is 100% by weight and the fraction of the sum of the polycarbonate and polytetramethylene glycol polyether polyols in component a2) is at least 50% by weight, preferably 60% by weight and particularly preferably at least 70% by weight.

In a3), polyols of the specified molecular weight range having up to 20 carbon atoms, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A, (2,2-bis(4-hydroxycyclohexyl)propane), trimethylolpropane, glycerol, pentaerythritol, and any desired mixtures thereof with one another can be used.

Also suitable are ester diols of the specified molecular weight range, such as α-hydroxybutyl ε-hydroxycaproate, ω-hydroxyhexyl γ-hydroxybutyrate, β-hydroxyethyl adipate or bis(β-hydroxyethyl) terephthalate.

In addition, in a3), it is also possible to use monofunctional compounds containing hydroxy groups. Examples of such monofunctional compounds are ethanol, n-butanol, ethylene glycol monobutyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol.

Hydroxy-functional, ionic or potentially ionic hydrophilizing agents a4) are understood as meaning all compounds which have at least one isocyanate-reactive hydroxyl group, and at least one functionality, such as, for example, —COOY, —SO₃Y, —PO(OY)₂ (Y⁺ for example=H⁺, NH₄⁺, metal cation), —NR₂, —NR₃⁺ (R=H, alkyl, aryl), which, upon interaction with aqueous media, enter into a pH-dependent dissociation equilibrium and, in this way, may be negatively, positively or neutrally charged.

Suitable ionically or potentially ionically hydrophilizing compounds corresponding to the definition of component a4) are, for example, mono- and dihydroxycarboxylic acids, mono- and dihydroxysulphonic acids, and also mono- and dihydroxyphosphonic acids and their salts, such as dimethylolpropionic acid, dimethylolbutyric acid, hydroxypivalic acid, malic acid, citric acid, glycolic acid, lactic acid, the propoxylated adduct of 2-butenediol and NaHSO₃, described for example in DE-A 2 446 440 (page 5-9, formula I-III), and also compounds which contain building blocks which can be converted to cationic groups, e.g. amine-based building blocks, such as N-methyldiethanolamine, as hydrophilic structural components.

Preferred ionic or potentially ionic hydrophilizing agents of component a4) are those of the type specified above which have an anionically hydrophilizing effect, preferably via carboxy or carboxylate and/or sulphonate groups.

Particularly preferred ionic or potentially ionic hydrophilizing agents are those which contain carboxyl and/or sulphonate groups as anionic or potentially anionic groups, such as the salts of dimethylolpropionic acid or dimethylolbutyric acid.

Suitable nonionically hydrophilizing compounds of component a4) are, for example, polyoxy-alkylene ethers which contain at least one hydroxy or amino group as isocyanate-reactive group.

Examples are the monohydroxy-functional polyalkylene oxide polyether alcohols having, on a statistical average, 5 to 70, preferably 7 to 55, ethylene oxide units per molecule, as are accessible through alkoxylation of suitable starter molecules (for example in Ullmanns Encyclopedia of Industrial Chemistry, 4th Edition, Volume 19, Verlag Chemie, Weinheim pp. 31-38).

These are either pure polyethylene oxide ethers or mixed polyalkylene oxide ethers, where they comprise at least 30 mol %, preferably at least 40 mol %, based on all of the alkylene oxide units present, of ethylene oxide units.

Particularly preferred nonionic compounds are monofunctional mixed polyalkylene oxide polyethers which have 40 to 100 mol % of ethylene oxide units and 0 to 60 mol % of propylene oxide units.

Suitable starter molecules for such nonionic hydrophilizing agents are saturated monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, such as, for example, diethylene glycol monobutyl ether, unsaturated alcohols, such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis-(2-ethylhexyl)amine, N-methyl- and N-ethylcyclohexylamine or dicyclohexylamine, and also heterocyclic secondary amines such as morpholine, pyrrolidine, piperidine or 1H-pyrazol. Preferred starter molecules are saturated monoalcohols of the type specified above. Particular preference is given to using diethylene glycol monobutyl ether or n-butanol as starter molecules.

Alkylene oxides suitable for the alkoxylation reaction are in particular ethylene oxide and propylene oxide which can be used in the alkoxylation reaction in any desired order or else in a mixture.

As component b1) it is possible to use di- or polyamines, such as 1,2-ethylenediamine, 1,2- and 1,3-diaminopropane, 1,4-diaminobutane, 1,6-diaminohexane, isophoronediamine, isomer mixture of 2,2,4- and 2,4,4-trimethylhexamethylenediamine, 2-methylpentamethylenediamine, diethylene-triamine, 1,3- and 1,4-xylylenediamine, α,α,α′,α′-tetramethyl-1,3- and -1,4-xylylenediamine and 4,4-diaminodicyclohexylmethane and/or dimethylethylenediamine. The use of hydrazine and/or hydrazides, such as adipic dihydrazide, is likewise possible.

Moreover, as component b1), it is also possible to use compounds which, besides a primary amino group, also have secondary amino groups, or besides an amino group (primary or secondary) also have OH groups. Examples thereof are primary/secondary amines, such as diethanolamine, 3-amino-1-methylaminopropane, 3-amino-1-ethylaminopropane, 3-amino-1-cyclohexylaminopropane, 3-Amino-1-methylaminobutane, alkanolamines such as N-aminoethylethanolamine, ethanolamine, 3-aminopropanol, neopentanolamine.

In addition, as component b1), it is also possible to use monofunctional amine compounds, such as, for example, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, suitable substituted derivatives thereof, amidamines of diprimary amines and monocarboxylic acids, monoketimes of diprimary amines, primary/tertiary amines, such as N,N-dimethylaminopropylamine.

Preference is given to using 1,2-ethylenediamine, hydrazine hydrate, 1,4-diaminobutane, isophoronediamine and diethylenetriamine.

Ionically or potentially ionically hydrophilizing compounds of component b2) are understood as meaning all compounds which have at least one isocyanate-reactive amino group and at least one functionality, such as e.g. —COOY, —SO₃Y, —PO(OY)₂ (Y for example=H, NH₄⁺, metal cation), —NR₂, —NR₃⁺ (R=H, alkyl, aryl), which, upon interaction with aqueous media, enters into a pH-dependent dissociation equilibrium and, in this way, may be positively, negatively or neutrally charged.

Suitable ionically or potentially ionically hydrophilizing compounds are, for example, mono- and diaminocarboxylic acids, mono- and diaminosuiphonic acids, and mono- and diaminophosphonic acids and their salts. Examples of such ionic or potentially ionic hydrophilizing agents are N-(2-aminoethyl)-β-alanine, 2-(2-aminoethylamino)ethanesulphonic acid, ethylenediaminepropyl- or -butylsulphonic acid, 1,2- or 1,3-propylenediamine-β-ethylsulphonic acid, glycine, alanine, taurine, lysine, 3,5-diaminobenzoic acid and the addition product of IPDI and acrylic acid (EP-A 0 916 647, example 1). Furthermore, cyclohexylaminopropanesulphonic acid (CAPS) from WO-A 01/88006 can be used as anionic or potentially anionic hydrophilizing agent.

Preferred ionic or potentially ionic hydrophilizing agents of component b2) are those of the type specified above which have a hydrophilizing effect via anionic, preferably carboxy or carboxylate and/or sulphonate groups.

Particularly preferred ionic or potentially ionic hydrophilizing agents b2) are those which contain carboxyl and/or sulphonate groups as anionic or potentially anionic groups, such as the salts of N-(2-aminoethyl)-β-alanine, of 2-(2-aminoethylamino)ethanesulphonic acid or of the addition product of IPDI and acrylic acid (EP-A 0 916 647, example 1).

For the hydrophilization, preference is given to using a mixture of anionic or potentially anionic hydrophilizing agents and nonionic hydrophilizing agents.

The ratio of NCO groups of the compounds from component a1) to NCO-reactive groups of components a2) to a4) in the preparation of the NCO-functional prepolymer is 1.05 to 3.5, preferably 1.2 to 3.0, particularly preferably 1.3 to 2.5.

The amino-functional compounds in stage B) are used in an amount such that the equivalent ratio of isocyanate-reactive amino groups of these compounds to the free isocyanate groups of the prepolymer is 40 to 150%, preferably between 50 to 125%, particularly preferably between 60 to 120%.

In a preferred embodiment, anionically and nonionically hydrophilized polyurethane dispersions are used, where, for their preparation, components a1) to a4) and b1) to b2) are used in the following amounts, where the individual amounts add up to 100% by weight:

5 to 40% by weight of component a1),

55 to 90% by weight of a2),

0.5 to 20% by weight of the sum of components a3) and b1)

0.1 to 25% by weight of the sum of the components component a4) and b2), where, based on the total amounts of components a1) to a4) and b1) to b2), 0.1 to 5% by weight of anionic or potentially anionic hydrophilizing agents a4) and b2) are used.

The amounts of component a1) to a4) and b1) and b2) are particularly preferably:

5 to 35% by weight of component a1),

60 to 90% by weight of a2),

0.5 to 15% by weight of the sum of the components a3) and b1)

0.1 to 15% by weight of the sum of the components component a4) and b2), where, based on the total amounts of the components a1) to a4) and b1) to b2), 0.2 to 4% by weight of anionic or potentially anionic hydrophilizing agents a4) and b2) are used.

The amounts of component a1) to a4) and b1) and b2) are very particularly preferably:

10 to 30% by weight of component a1),

65 to 85% by weight of a2),

0.5 to 14% by weight of the sum of the components a3) and b1) p 0.1 to 13.5% by weight of the sum of components a4) and b2), where, based on the total amounts of components a1) to a4), 0.5 to 3.0% by weight of anionic or potentially anionic hydrophilizing agents are used.

Particularly preferred embodiments of the polyurethane dispersions (I) comprise, as component, as component a1), isophorone diisocyanate and/or 1,6-hexamethylene diisocyanate and/or the isomeric bis(4,4′-isocyanatocyclohexyl)methanes in combination with a2) a mixture of polycarbonate polyols and polytetramethylene glycol polyols.

The fraction of the polycarbonate polyols in the mixture a2) is, for example, 20 to 80% by weight and 80 to 20% by weight of polytetramethylene glycol polyols. Preference is given to a fraction of from 30 to 75% by weight of polytetramethylene glycol polyols and 25 to 70% by weight of polycarbonate polyols. Particular preference is given to a fraction of from 35 to 70% by weight of polytetramethylene glycol polyols and 30 to 65% by weight of polycarbonate polyols, in each case with the proviso that the sum of the percentages by weight of the polycarbonate and polytetramethylene glycol polyols is 100% by weight and the fraction of the sum of component a2) in the polycarbonate and polytetramethylene glycol polyether polyols is at least 50% by weight, preferably 60% by weight and particularly preferably at least 70% by weight.

The preparation of such polyurethane dispersions can be carried out in one or more stage(s) in homogeneous phase or, in the case of a multistage reaction, sometimes in disperse phase. Following complete or partial polyaddition from a1) to a4), a dispersing, emulsifying or dissolving step takes place. Afterwards, a further polyaddition or modification in the disperse phase optionally takes place.

In this connection, it is possible to use all processes known from the prior art, such as, for example, prepolymer mixing processes, acetone processes or melt dispersion processes. Preference is given to operating according to the acetone process.

For the preparation according to the acetone process, the constituents a2) to a4), which must have no primary or secondary amino groups, and the polyisocyanate component a1) for the preparation of an isocyanate-functional polyurethane prepolymer are completely or partly initially introduced and optionally diluted with a solvent which is miscible with water but inert towards isocyanate groups, and heated to temperatures in the range from 50 to 120° C. To accelerate the isocyanate addition reaction, the catalysts known in polyurethane chemistry can be used.

Suitable solvents are the customary aliphatic, keto-functional solvents such as acetone, 2-butanone, which can be added not only at the start of the preparation, but optionally also later in parts. Preference is given to acetone and to 2-butanone.

Other solvents (cosolvents) such as xylene, toluene, cyclohexane, butyl acetate, methoxypropyl acetate, N-methylpyrrolidone, N-ethylpyrrolidone, solvents with ether or ester units can additionally be used and can be completely or partly distilled off or remain in their entirety in the dispersion in the case of N-methylpyrrolidone, N-ethylpyrrolidone.

In a particular embodiment of the invention, cosolvents are dispensed with entirely.

Then, any constituents of a1) to a4) not added at the start of the reaction are metered in.

The reaction of components a1) to a4) to give the prepolymer takes place partially or completely, but preferably completely. Thus, polyurethane prepolymers which contain free isocyanate groups are obtained without a diluent or in solution.

In the neutralization step for the partial or complete conversion of potentially anionic groups to anionic groups, bases such as tertiary amines, for example trialkylamines having 1 to 12, preferably 1 to 6, carbon atoms in each alkyl radical or alkali metal bases such as the corresponding hydroxides are used.

Examples thereof are trimethylamine, triethylamine, methyldiethylamine, tripropylamine, N-methylmorpholine, methyldiisopropylamine, ethyldiisopropylamine and diisopropylethylamine The alkyl radicals can, for example, also carry hydroxyl groups, as in the case of the dialkylmonoalkanol-, alkyldialkanol- and trialkanolamines. Neutralizing agents which can be used are optionally also inorganic bases, such as aqueous ammonia solution or sodium or potassium hydroxide.

Preference is given to ammonia, triethylamine, triethanolamine, dimethylethanolamine or diisopropylethylamine and sodium hydroxide.

In the case of cationic groups, sulphuric acid dimethyl ester or succinic acid or phosphoric acid are used.

The quantitative amount of the bases is 50 and 125 mol %, preferably between 70 and 100 mol %, of the quantitative amount of the acid groups to be neutralized. The neutralization can also take place at the same time as the dispersion by the dispersion water already comprising the neutralizing agent.

Afterwards, in a further process step, if it has not yet taken place or has only taken place partly, the resulting prepolymer is dissolved with the help of aliphatic ketones such as acetone or 2-butanone.

The aminic components b1), b2) can optionally be used in water- or solvent-diluted form in the process according to the invention individually or in mixtures, where in principle any order of the addition is possible.

If water or organic solvent are co-used as diluents, then the diluent content in the component used in b) for the chain extension is preferably 70 to 95% by weight.

The dispersion preferably takes place after the chain extension. For this, either the dissolved and chain-extended polyurethane polymer is introduced, optionally with severe shear, such as, for example, vigorous stirring, into the dispersion water or, vice versa, the dispersion water is stirred into the chain-extended polyurethane polymer solutions. Preferably, the water is added to the dissolved chain-extended polyurethane polymer.

The solvent still present in the dispersions after the dispersion step is usually then removed by distillation. Removal as early as during the dispersion is likewise possible.

The residual content of organic solvents in the dispersions is typically less than 1.0% by weight, preferably less than 0.5% by weight, particularly preferably less than 0.1% by weight and very particularly preferably less than 0.05% by weight, based on the total dispersion.

The pH of the dispersions is typically less than 9.0, preferably less than 8.5, particularly preferably less than 8.0.

The solids content of the polyurethane dispersion is typically 20 to 70% by weight, preferably 30 to 65% by weight, particularly preferably 40 to 63% by weight and very particularly preferably from 50 to 63% by weight.

It is also possible to modify the polyurethane-polyurea dispersions (I) by polyacrylates. For this, an emulsion polymerization of olefinically unsaturated monomers, for example esters of (meth)acrylic acid and alcohols having 1 to 18 carbon atoms, styrene, vinyl esters or butadiene is carried out in the presence of the polyurethane dispersion, as is described, for example, in DE-A-1 953 348, EP-A-0 167 188, EP-A-0 189 945 and EP-A-0 308 115. The monomers contain one or more olefinic double bonds. In addition, the monomers can contain functional groups such as hydroxyl, epoxy, methylol or acetoacetoxy groups.

In a particularly preferred embodiment of the invention, this modification is dispensed with.

In principle, it is possible to mix the polyurethane-polyurea dispersions (I) with other aqueous binders. Such aqueous binders can be composed, for example, of polyester, polyacrylate, polyepoxide or polyurethane polymers. The combination with X-ray-curable binders, as are described e.g. in EP-A-0 753 531, is also possible. It is likewise possible to blend the polyurethane-polyurea dispersions (I) with other anionic or nonionic dispersions, such as, for example, polyvinyl acetate, polyethylene, polystyrene, polybutadiene, polyvinyl chloride, polyacrylate and copolymer dispersions.

In a particularly preferred embodiment of the invention, this modification is dispensed with.

For the preparation of the chewing foams according to the invention, the foamed polymers can be applied to a wide variety of surfaces or into moulds in a wide variety of ways, or be extruded as strands. However, preference is given to pouring, knife-coating, rolling, coating, injection-moulding, or spraying.

In principle, for producing the chewing foams, a plurality of layers can also be applied to a substrate or be poured into a mould, for example to produce particularly tall foam pads.

Moreover, the foamed polymers can also be used in combination with other carrier materials, such as, for example, textile carriers, paper etc., for example by prior application (for example coating).

Whereas the foamed polymers prior to curing have a preferred foam density of from 200 to 700 g/l, particularly preferably 300 to 600 g/l, the density after curing is preferably 50 to 600 g/l, particularly preferably 100 to 500 g/l.

When producing the chewing foams, beside synthetic or chemically modified natural polymers or the starting materials (I) required for their formation, it is also possible to co-use foam auxiliaries (II), crosslinkers (III), thickeners (IV), auxiliaries (V) and cosmetic additives (VI). The material of the profile body according to the invention thus also includes these substances.

Suitable foam auxiliaries (II) are standard commercial foam generators and/or stabilizers, such as water-soluble fatty acid amides, sulphosuccinamides, hydrocarbon sulphonates, hydrocarbon sulphates or fatty acid salts, where the lipophilic radical preferably contains 12 to 24 carbon atoms.

Preferred foam auxiliaries (II) are alkanesulphonates or alkane sulphates having 12 to 22 carbon atoms in the hydrocarbon radical, alkylbenzenesulphonates or alkylbenzene sulphates having 14 to 24 carbon atoms in the hydrocarbon radical or fatty acid amides or fatty acid salts having 12 to 24 carbon atoms.

The aforementioned fatty acid amides are preferably fatty acid amides of mono- or di-(C2-3-alkanol)amines. Fatty acid salts may be, for example, alkali metal salts, amine salts or unsubstituted ammonium salts.

Such fatty acid derivatives are typically based on fatty acids such as lauric acid, myristic acid, palmitic acid, oleic acid, stearic acid, ricinoleic acid, behenic acid or arachidic acid, coconut fatty acid, tallow fatty acid, soya fatty acid and hydrogenation products thereof.

Particularly preferred foam auxiliaries (II) are sodium lauryl sulphate, sulphosuccinamides and ammonium stearates, and mixtures thereof.

Suitable crosslinkers (III) are, for example, unblocked polyisocyanate crosslinkers, amide- and amine-formaldehyde resins, phenol resins, aldehyde and ketone resins, such as, for example, phenol-formaldehyde resins, resols, furan resins, urea resins, carbamic acid ester resins, triazine resins, melamine resins, benzoguanamine resins, cyanamide resins or aniline resins.

In a particularly preferred embodiment, the use of crosslinkers (III) is dispensed with entirely.

Suitable thickeners (IV) are compounds which allow the viscosity of the constituents or of their mixtures to be adjusted such that the generation and processing of the foam according to the invention is favoured. Suitable thickeners are standard commercial thickeners such as, for example, natural organic thickeners, for example dextrins or starch, organically modified natural substances, for example cellulose ethers or hydroxyethylcellulose, organically fully synthetic substances, for example polyacrylic acids, polyvinylpyrrolidones, poly(meth)acrylic compounds or polyurethanes (associative thickeners), and also inorganic thickeners, for example bentonites or silicas. Preference is given to using organically fully synthetic thickeners. Particular preference is given to using acrylate thickeners which are optionally further diluted with water before being added. Preferred standard commercial thickeners are, for example, Mirox® AM (BGB Stockhausen GmbH, Krefeld, Germany), Walocel® MT 6000 PV (Wolff Cellulosics GmbH & Co KG, Walsrode, Germany), Rheolate® 255 (Elementies Specialities, Gent, Belgium), Collacral® VL (BASF AG, Ludwigshafen, Germany).

Auxiliaries (V) within the context of the invention are, for example, antioxidants and/or photoprotective agents and/or other additives, such as, for example, emulsifiers, fillers, softeners, pigments, silicic acid sols, aluminium, clay, dispersions, flow agents or thixotropic agents.

Cosmetic additives (VI) within the context of the invention are, for example, flavourings and aroma substances, abrasive substances, dyes, sweeteners, etc., and active ingredients, such as fluoride compounds or tooth whiteners.

Foam auxiliaries (II), crosslinkers (III), thickeners (IV) and auxiliaries (V) can in each case constitute up to 20% by weight and cosmetic additives (VI) up to 80% by weight, based on the foamed and dried chewing foams.

In the preparation of the chewing foams, preference is given to using 80 to 99.5% by weight of the synthetic or chemically modified natural polymers or of the starting materials (I) required for their formation, 0 to 10% by weight of component (II), 0 to 10% by weight of component (III), 0 to 10% by weight of component (IV), 0 to 10% by weight of component (V) and 0.1 to 20% by weight of component (VI), where the sum refers to the nonvolatile fractions of components (I) to (VI) and the sum of the individual components (I) to (VI) adds up to 100% by weight.

In the production of the chewing foams, particular preference is given to using 80 to 99.5% by weight of the synthetic or chemically modified natural polymers or of the starting substances (I) required for their formation, 0 to 10% by weight of component (II), 0 to 10% by weight of component (IV), 0 to 10% by weight of component (V) and 0.1 to 15% by weight of component (VI), where the sum refers to the nonvolatile fractions of components (I) to (VI) and the sum of the individual components (I) to (VI) adds up to 100% by weight.

Very particular preference is given to using 80 to 99.5% by weight of the synthetic or chemically modified natural polymers or the starting substances (I) required for their formation, 0.1 to 10% by weight of component (II), 0.1 to 10% by weight of component (IV), 0.1 to 10% by weight of component (V) and 0.1 to 15% by weight of component (VI), where the sum refers to the nonvolatile fractions of components (I) to (VI) and the sum of the individual components (I) to (VI) adds up to 100% by weight.

The shaping of the profile bodies according to the invention can take place firstly through application of the foamed polymers or of the starting materials required for their formation into a suitable three-dimensional mould.

Likewise possible is the extrusion of strands which already have the shape according to the invention with regard to the cross section shape. The thickness of the chewing foam is then achieved after shaping before, during or after hardening by cutting the strands according to the desired thickness.

Preferably, however, in the production, the procedure is such that the polymers or the starting materials required for their production are applied to the surface of a substrate in an already foamed form or with foam formation and are cured and then the profile body is shaped.

The present invention therefore further provides a process for producing a profile body according to the invention, comprising the steps:
application of a foam material to a flat substrate
curing and/or drying the foam material
shaping the profile body by cutting out or punching out.

The thickness of the foam layer is dependent on the desired thickness of the chewing foam then to be cut out or punched out of the flat structure. Preferably, the thickness of such a flat foam after the drying step is ≧8 mm to ≦35 mm, particularly preferably ≧9 mm to ≦30 mm.

The curing and/or drying preferably takes place at a temperature of 25° C. to 150° C., preferably 30° C. to 145° C., particularly preferably at 60° C. to 145° C. The drying can take place in a conventional dryer. Drying in a microwave (HF) dryer is likewise possible.

For the cutting out or punching out, methods such as hot-wire cutting, laser cutting, water-jet cutting or roll punching can be used. Particular preference is given to using a punching process.

In one embodiment of the process according to the invention, the foam material comprises a polyurethane dispersion as described above. Included in this are the cured and/or dried foams.

The present invention likewise provides the use of a profile body according to the invention for the cleaning of teeth. These may be human teeth, but also the teeth of pets or useful animals.

The invention is illustrated further by reference to the drawings below.

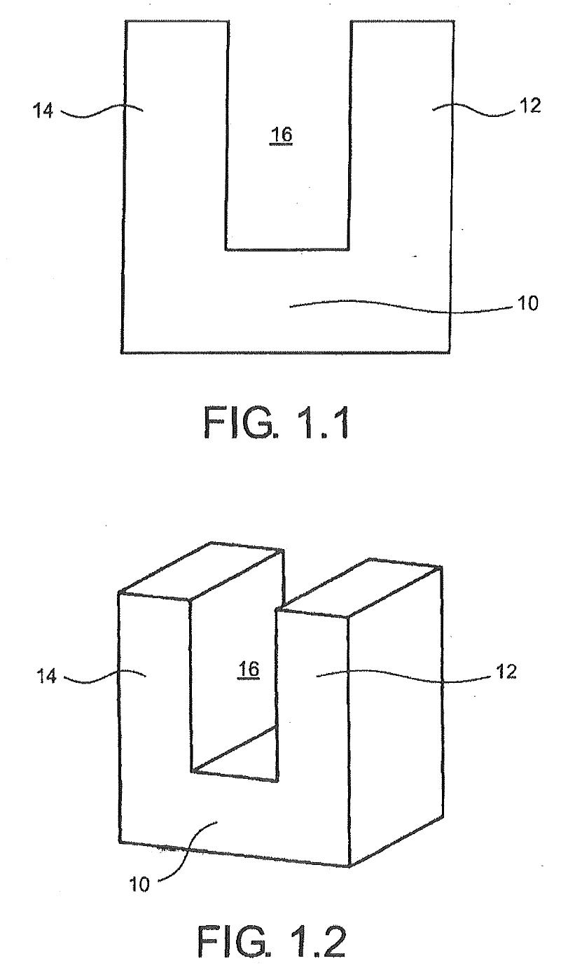

FIG. 1.1 and FIG. 1.2 show a frontal and oblique view of a profile body according to the invention

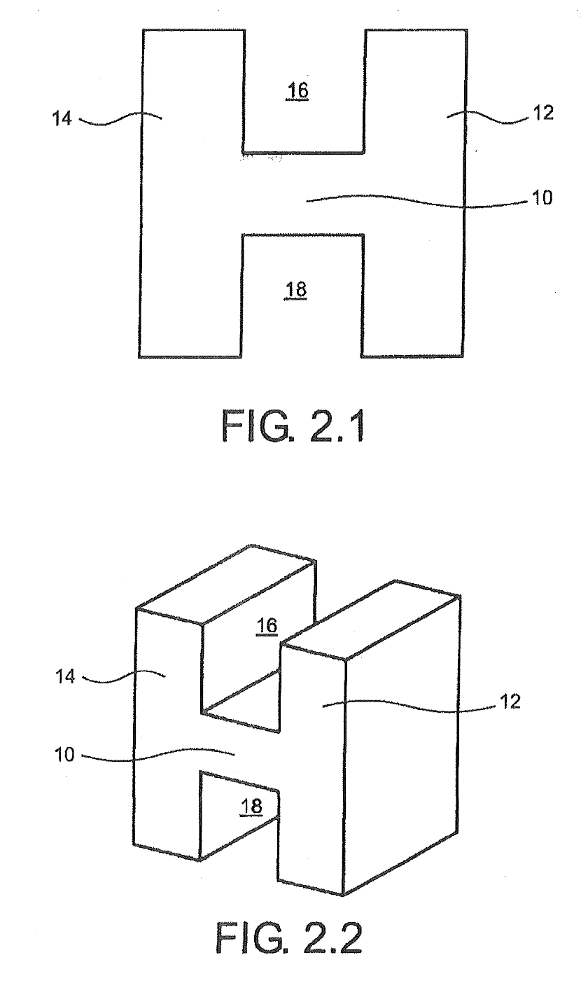

FIG. 2.1 and FIG. 2.2 show a frontal and oblique view of a further profile body according to the invention

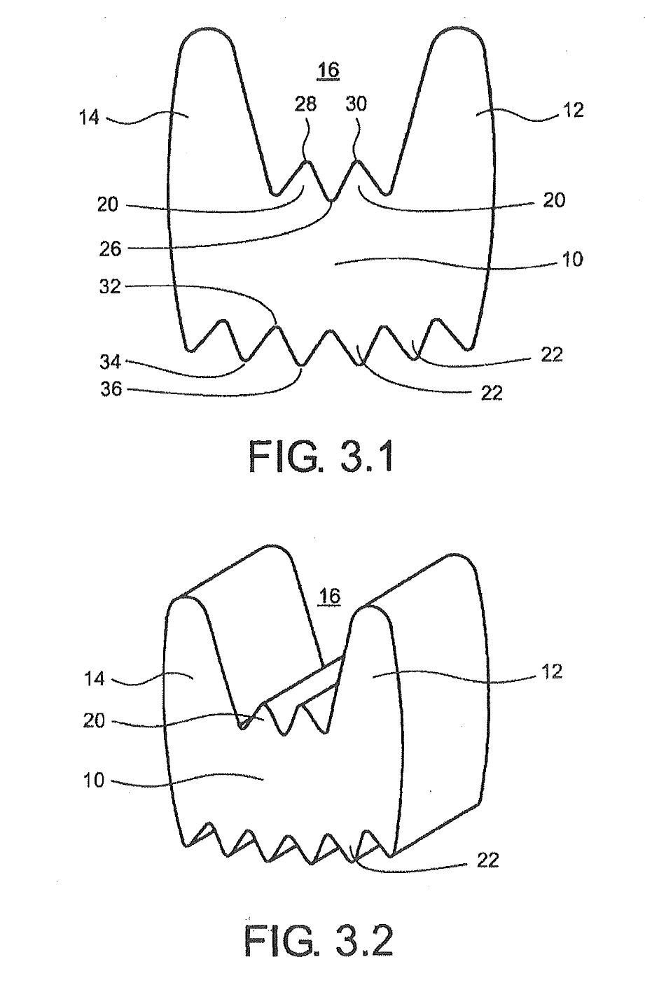

FIG. 3.1 and FIG. 3.2 show a frontal and oblique view of a further profile body according to the invention

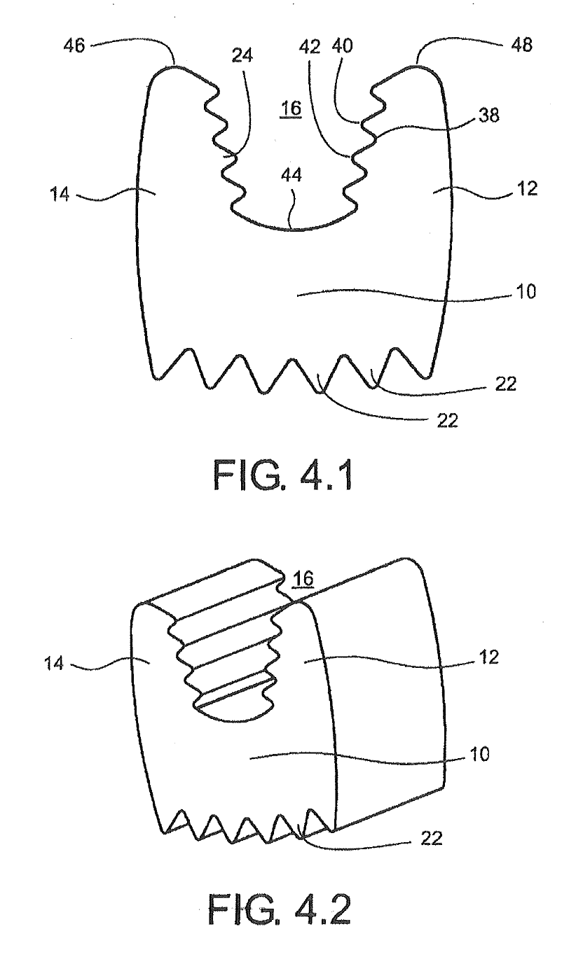

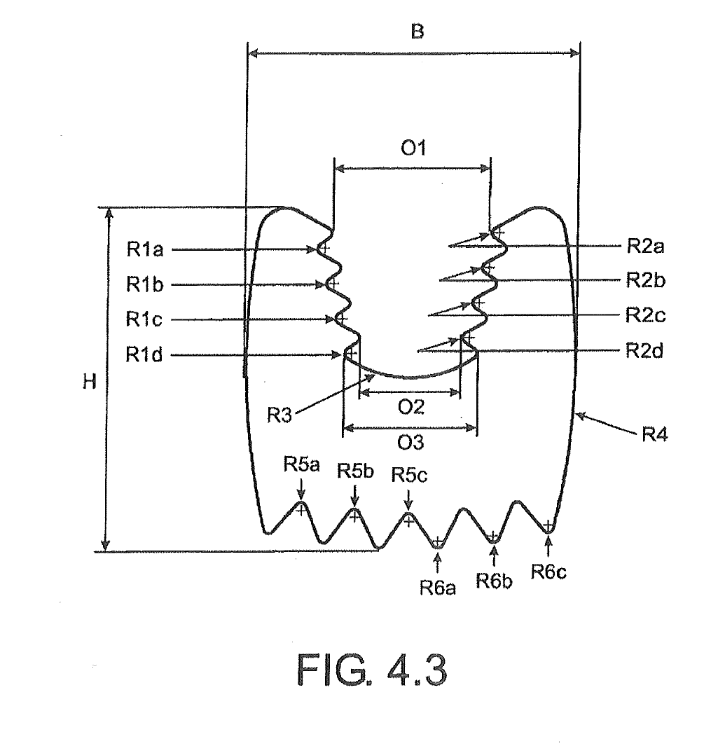

FIG. 4.1 and FIG. 4.2 show a frontal and oblique view of a further profile body according to the invention

FIG. 4.3 shows dimensions of the frontal view of the profile body from FIG. 4.1

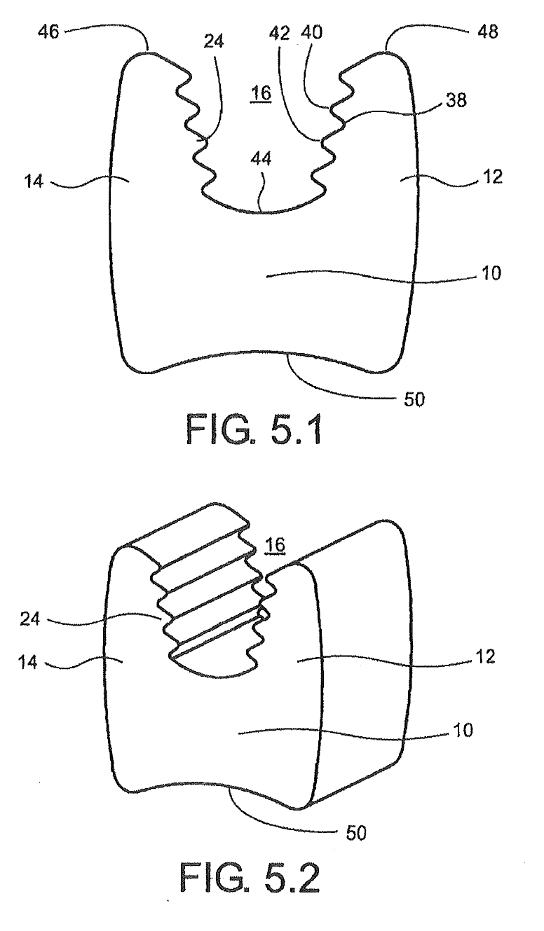

FIG. 5.1 and FIG. 5.2 show a frontal and oblique view of a further profile body according to the invention

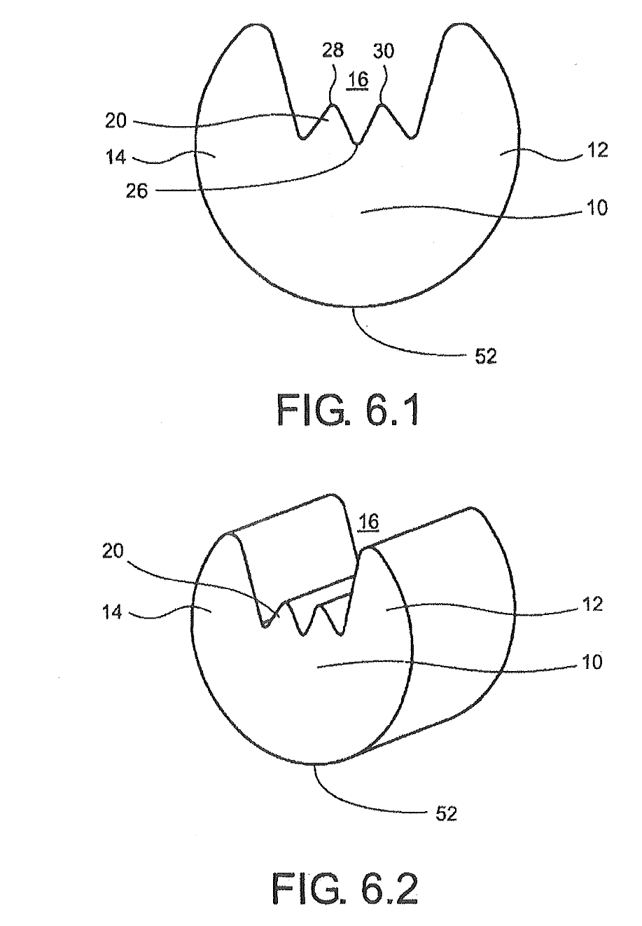

FIG. 6.1 and FIG. 6.2 show a frontal and oblique view of a further profile body according to the invention

FIG. 1.1 shows a frontal view of a profile body according to the invention. The frontal view corresponds to the cross sectional view according to the explanations already given. FIG. 1.2 shows an oblique view of the same profile body. The profile body shown here is U-shaped in its cross section. In the cross section, the profile body has a horizontal floor section 10. Adjoining the floor section 10 and arranged opposite one another are the two wall sections 12 and 14. Within the context of the present invention, the height of the profile body is as the maximum orientation in the cross section of the profile body in the direction of the first and second wall section. Transferred to FIG. 1.1, the height of the profile body is thus, for example, the distance from the right-hand lower corner of the cross section profile, i.e. the point at which the horizontal floor body 10 converts to the perpendicular wall section 12, up to the right-hand upper corner of the cross section profile, i.e. the point at which perpendicular wall section 12 converts to the horizontal. The width of the profile body is accordingly defined perpendicularly to the height as the maximum expanse of the profile body. Transferred to FIG. 1.1, this would be the distance from the left-hand lower corner of the cross section profile, i.e. the point at which the horizontal floor section 10 converts to the perpendicular wall section 14, as far as the right-hand lower corner of the cross section profile, i.e. the point at which the horizontal floor section 10 converts to the perpendicular wall section 12.

Limited to the sides by the wall sections 12 and 14 and limited downwards by the floor section 10, a gap 16 is formed. This gap can accommodate a tooth or a plurality of teeth as part of a row of teeth. If the profile body is chewed, then the tooth impacts with its point or its chewing surface onto the surface of the floor section 10 facing the gap 16. At the same time, the flanks of the tooth contact the surfaces of the wall sections 12 and 14 facing the gap 16. In this way, several sides of the tooth can be cleaned at the same time.

FIG. 2.1 shows a front view of a further profile body according to the invention. The frontal view corresponds to the cross sectional view according to the explanations already given. FIG. 2.2 shows an oblique view of the same profile body. The profile body shown here is H-shaped in its cross section. In addition to the profile body from FIG. 1.1 and FIG. 1.2, this profile body additionally has a further gap 18 to accommodate a tooth. This gap 18 is located on the side of the floor section 10 which lies opposite the gap 16. Here too, the floor of the gap 18 is formed by the floor section 10 and the sides are formed by the wall sections 12 and 14. Through such an arrangement with two gaps, the teeth of the upper jaw and of the lower jaw can be cleaned at the same time during chewing.

FIG. 3.1 shows a frontal view of a further profile body according to the invention. The frontal view corresponds to the cross sectional view according to the explanations already given. FIG. 3.2 shows an oblique view of the same profile body. Here, the wall sections 12 and 14 are convexly structured. The floor section 10, when seen in cross section, fauns elevations 20 on its side facing the gap 16. Likewise, the floor section 10 forms elevations 22 on its side opposite the gap 16. As a result of such elevations, depressions in the chewing surfaces of the teeth can be better reached. The deepest points 26 and 32 lie between the elevations 20 and 22. These deepest points are directly adjacent on each side from the highest points 28 and 30 on the one side and 34 and 36 on the other side. It can thus be stated what dimension the elevations 20 and 22 have. The height of these elevations is ascertained by firstly drawing a joining line between highest points 34, 36 adjacent to a deepest point 28, 32. The distance of the deepest point 28, 32 at the right angle to this joining line then gives the height of the elevations 20, 22.

FIG. 4.1 shows a frontal view of a further profile body according to the invention. The frontal view corresponds to the cross sectional view according to the explanations already given. FIG. 4.2 shows an oblique view of the same profile body. Here too, the wall sections 12 and 14 are convexly structured. The floor section 10 forms, when seen in cross section, elevations 22 on its side opposite the gap 16. Furthermore, wall sections 12 and 14 each form elevations 24 on their side facing the gap 16. In this way, depressions on the tooth flanks, for example at the transition between tooth and gum, can also be better reached. The height of these elevations 24 can be stated analogously to the height of the elevations 20, 22 by ascertaining the distance of a deepest point 38 between two directly adjacent highest points 40, 42 at a right angle to the joining line between these points. To indicate how deep the gap 16 is, the distance of the deepest point 44 on the side of the floor section 10 facing the gap 16 at a right angle to a joining line between the highest point 48 of the first wall section 12 and the highest point 46 of the wall section 14 can be used.

FIG. 4.3 shows by way of example dimensions of the frontal view according to FIG. 4.1. However, these also apply generally in the corresponding manner for the profile bodies according to the invention. The height H shows the maximum expanse of the profile body in the direction of the first and second wall section. Perpendicular to the height H, the maximum expanse of the profile body defines the width B. The dimension of the gap for accommodating a tooth can be given by the width of the uppermost opening O1, the width of the lowest narrowing O2 and also the width (maximum expanse) of the floor section on the side O3 facing the gap.

The outer contours of the profile body can for the greatest part be expressed as circular arc segments. The elevations and the corresponding depressions of the first and second wall section on the side facing the gap can thus be described, for example. In this connection, the crosses in FIG. 4.3 indicate the position of the circle centres whose circular arc segments form the contours. On the left-hand wall section, the indicators R1a to R1d symbolize the radii of the circular arcs at the depressions between the elevations. On the right-hand wall section, the indicators R2a to R2d symbolize the radii of the circular arcs of the elevations.

The curvature of the contour of the side of the floor section facing the gap is given by the radius R3. Finally, the curvature of the outer contours of the first and second wall section is described by the radius R4.

In the profile bodies according to the invention, the height H can, for example, assume values of ≧10 mm to ≦20 mm The width B can also, for example, assume values of ≧10 mm to ≦20 mm. The width of the uppermost opening of the gap O1 can, for example, assume values of ≧5 mm to ≦10 mm. The width of the lowest narrowing of the gap O2 can, for example, assume values of ≧2 mm to ≦6 mm. The maximum expanse of the floor section on the side O3 facing the gap can, for example, assume values of ≧3 mm to ≦9 mm. The radii of curvature of the bulges of the first and second wall section on the side facing the gap and the corresponding depression-describing circles R1a, R1b, R1c and R1d and also R2a, R2b, R2c and R2d can, for example, independently of one another, assume values of ≧0.1 mm to ≦0.5 mm. The curvature of the contour of the side of the floor section R3 facing the gap can, for example, assume values of ≧1 mm to ≦10 mm. The curvature of the outer contours of the first and second wall section R4 can, independently of one another, for example assume values of ≧20 mm to ≦50 mm for the two wall sections. The radii of curvature of the bulges of the floor section on the side facing away from the gap and the corresponding depression-describing circles R5a, R5b and R5c and also R6a, R6b and R6c can, for example, independently of one another, assume values of ≧0.1 mm to ≦0.5 mm

It is preferred if the following dimensions are present: B=16 mm; H=16 mm; O1=7 mm; O2=4 mm; R1a, R1b, R1c, R1d=0.30 mm; R2a, R2b, R2c, R2d=0.30 mm; R3=4 mm; R4=36 mm; R5a, R5b, R5c=0.3 mm; R6a, R6b, R6c=0.3 mm. It is likewise preferred if the dimension O3 is 5 mm The stated dimensions can in practise have a production tolerance of ±10%.

With regard to the dimensions in the third spatial dimension, the profile bodies according to the invention can generally have a thickness of ≧10 mm to ≦20 mm, preferably from ≧12 mm to ≦14 mm, more preferably of 13 mm.

FIG. 5.1 shows a frontal view of a further profile body according to the invention. The frontal view corresponds to the cross sectional view according to the explanations already given. FIG. 5.2 shows an oblique view of the same profile body. In contrast to the profile body from FIG. 4.1 and FIG. 4.2, the side 50 of the floor section 10 opposite the gap 16 is concave towards this gap 16 and constructed without specific elevations. By virtue of these indentations, the profile body can be better fixed upon chewing.

FIG. 6.1 shows a frontal view of a further profile body according to the invention. The frontal view corresponds to the cross sectional view according to the explanations already given. FIG. 6.2 shows an oblique view of the same profile body. In this profile body, the outer limits of the wall sections 12, 14 and the limit to the side 52 of the floor section 10 opposite the gap 16 are parts of a single circular arc. On the side facing the gap 16, the floor section 10 has elevations 20. By virtue of the largely circular configuration of the edge of the profile body, the starting point of the tongue when moving the profile body in the mouth is always the same.

The invention is also illustrated further by reference to the following examples.

Substances used and abbreviations:

Diaminosulphonate: NH₂—CH₂CH₂—NH—CH₂CH₂—SO₃Na (45% strength in water)

Desmophen® C2200: Polycarbonate polyol, OH number 56 mg KOH/g, number-average molecular weight 2000 g/mol (Bayer MaterialScience AG, Leverkusen, Germany)

PolyTHF® 2000: Polytetramethylene glycol polyol, OH number 56 mg KOH/g, number-average molecular weight 2000 g/mol (BASF AG, Ludwigshafen, Germany)

PolyTHF® 1000: Polytetramethylene glycol polyol, OH number 112 mg KOH/g, number-average molecular weight 1000 g/mol (BASF AG, Ludwigshafen, Germany)

Polyether LB 25: (monofunctional polyether based on ethylene oxide/propylene oxide of number-average molecular weight 2250 g/mol, OH number 25 mg KOH/g (Bayer MaterialScience AG, Leverkusen, Germany)

Stokal® STA: aqueous ammonium stearate solution (Bozzetto GmbH, Krefeld, Germany)

Plantacare 1200 UP alkyl polyglycosides (Cognis GmbH, Düsseldorf, Germany)

Na-Saccharin: sweetener (Merck, Darmstadt KGaA, Germany)

Sucralose: sweetener (Symrise, Holzminden, Germany)

L-Menthol Freeflow (PN 600129): 1-menthol free-flowing (mixture consisting of 1-menthol and 1% by weight of silicon dioxide) (Symrise, Holzminden, Germany)

Peppermint aroma (PN 10946): spray-dried peppermint oil with up to 40% by weight content based on gum arabic (Symrise, Holzminden, Germany)

Peppermint aroma (PN 204125): spray-dried peppermint oil with up to 40% by weight content based on gum arabic (Symrise, Holzminden, Germany)

Optacool® 150104: mixture of various physiological cooling active ingredients (Symrise, Holzminden Germany)

Optaflow® 225488 mixture of various physiological flow active ingredients (Symrise, Holzminden Germany)

Sorbitol sweetener (Merck, Darmstadt KGaA, Germany)

Duacert FD&C Blue No. 310605 dye (Sensient, Geesthacht, Germany)

The numbers designated PN are product numbers from Symrise (Holzminden, Germany).

### EXAMPLE 1

### Preparation of a Polyurethane-Polyurea Dispersion (I)

761.3 g of Desmophen® C2200, 987.0 g of PolyTHF® 2000, 375.4 g of PolyTHF® 1000 and 53.2 g of polyether LB 25 were heated to 70° C. Then, at 70° C., over the course of 5 minutes, a mixture of 237.0 g of hexamethylene diisocyanate and 313.2 g of isophorone diisocyanate was added and stirred under reflux until the theoretical NCO value was reached. The finished prepolymer was dissolved with 4850 g of acetone at 50° C. and then a solution of 1.8 g of 25.1 g of ethylenediamine, 61.7 g of diaminosulphonate, 116.5 g of isophoronediamine and 1030 g of water was metered in over the course of 10 minutes. The after-stirring time was 10 minutes. The mixture was then dispersed by adding 1061 g of water. The solvent was removed by distillation in vacuo. A storage-stable dispersion with a solids-body content of 57% was obtained.

### EXAMPLE 2

### Preparation of a Coating Material

100 g of the polyurethane dispersion from example 1 and 20 g of water, 6 g of a 0.1% strength aqueous solution of Na Saccharin, 6 g of L-Menthol Freeflow L 6000129 (Symrise, Holzminden, Germany), 6 g of a 0.2% strength aqueous solution of Sucralose, 6 g of Optacool 150104 (Symrise, Holzminden, Germany), 6 g of Optacool 225488 (Symrise, Holzminden, Germany), 0.4 g of a 0.1% strength aqueous solution of the dye Duacert FD&C Blue No. 310605 (Sensient, Belgium) are mixed at room temperature and stirred together.

### EXAMPLE 3

### Preparation According to the Invention of an Aromatized Chewing Foam

1000 g of the dispersion (I) obtained from example 1 were mixed with 10 g of Plantacare 1200 UP and 15 g of Stokal STA, 30 g of a 0.2% strength aqueous solution of Na Saccharin and 30 g of L-Menthol Freeflow PN 600129 and then foamed by introducing air with the help of a hand-mixing device to a foam litre weight of 300 g/l. 47.5 g of the foamed composition were then poured into a mould made of release paper (VEZ Mat, Sappi, Brussels, Belgium) with dimensions 70×140×10 mm (width×depth×height), where a wet layer thickness of 13 mm was achieved. 14 such casting moulds were then dried in an experimental microwave installation (MWT k/1,2-3 LK reg. from EL-A Verfahrenstechnologie Heidelberg, Germany) for 30 minutes at 30% power (3.6 kW at maximum power).

The material was then cut into a shape according to FIGS. 4.1 to 4.2 by means of water-jet cutting. The profile body had the following dimensions in accordance with the designations in FIG. 4.3: B=16.04 mm; H=16.47 mm; O1=6.80 mm; O2=4.00 mm; R1a, R1b, R1c, R1d=0.30 mm; R2a, R2b, R2c, R2d=0.30 mm; R3=3.66 mm; R4=36.50 mm; R5a, R5b, R5c=0.27 mm; R6a, R6b, R6c=0.27 mm The dimension O3 was estimated here as 5 mm. The thickness of the profile body was 13 mm.

All sides of the profile body were painted with the coating material prepared in example 2 using a paintbrush and then dried in a convection oven at 130° C. for 30 minutes.

### EXAMPLE 4

### Preparation According to the Invention of an Aromatized Chewing Foam

1000 g of the dispersion (I) obtained from example 1 were mixed with 10 g of Plantacare 1200 UP and 15 g of Stokal STA, 30 g of a 0.2% strength aqueous solution of Na Saccharin and 30 g of L-Menthol Freeflow PN 600129 and then foamed by introducing air with the help of a hand-mixing device to a foam litre weight of 300 g/l. 47.5 g of the foamed composition were then poured into a mould made of release paper (VEZ Mat, Sappi, Brussels, Belgium) with dimensions 70×140×10 mm (width×depth×height), where a wet layer thickness of 13 mm was achieved. 14 such casting moulds were then dried in an experimental microwave installation (MWT k/1,2-3 LK reg. from EL-A Verfahrenstechnologie Heidelberg, Germany) for 30 minutes at 30% power (3.6 kW at maximum power).

The material was then cut into a shape according to FIGS. 4.1 to 4.2 by means of water-jet cutting. The profile body had the following dimensions according to the designations in FIG. 4.3: B=16.04 mm; H=16.47 mm; O1=6.80 mm; O2=4.00 mm; R1a, R1b, R1c, R1d=0.30 mm; R2a, R2b, R2c, R2d=0.30 mm; R3=3.66 mm; R4=36.50 mm; R5a, R5b, R5c=0.27 mm; R6a, R6b, R6c=0.27 mm. The dimension O3 was estimated here as 5 mm. The thickness of the profile body was 13 mm.

All sides of the mould were painted with the coating material prepared in example 2 using a paintbrush and then dried in a convection oven at 130° C. for 30 minutes.

Then, using a 1 mm spatula, 0.06 g of the following composition A was applied to the side of the floor section facing the gap: 0.73 g of a 1% strength aqueous solution of FD&C Blue No. 1C.I.42090 with Cert. E133 (Symrise, Holzminden, Germany), 9.1 g of Optamint peppermint aroma SD 10946 (Symrise, Holzminden, Germany), 36.4 g of peppermint aroma SD 204125 (Symrise, Holzminden, Germany), 1.82 g of a 10% strength aqueous solution of sodium saccharin, 18.2 g of a 70% strength aqueous solution of Sorbitol, 1.82 g of a 10% strength solution of Sucralose, 31.9 g of water.

Then, using a paintbrush, 0.12 g of the following composition B was applied to the side of the floor section opposite the gap: 0.17 g of a 1% strength aqueous solution of FD&C Blue No. 1C.I.42090 with Cert. E133 (Symrise, Holzminden, Germany), 0.6 g of titanium dioxide E 171/C.I. 77891 powder pigment (Symrise, Holzminden, Germany), 9.2 g of Optamint peppermint aroma SD 10946 (Symrise, Holzminden, Germany), 36.4 g of peppermint aroma SD 204125 (Symrise, Holzminden, Germany), 1.8 g of a 10% strength aqueous solution of sodium saccharin, 18.2 g of a 70% strength aqueous solution of Sorbitol, 1.82 g of a 10% strength solution of Sucralose, 31.8 g of water. The chewing foam was then dried in a convection oven at 130° C. for 5 minutes.

### EXAMPLE 5

### Comparative Example

### Preparation of a Cube-Shaped Aromatized Chewing Foam

1000 g of the dispersion (I) obtained from example 1 were mixed with 10 g of Plantacare 1200 UP and 15 g of Stokal STA, 30 g of a 0.2% strength aqueous solution of Na Saccharin and 30 g of L-Menthol Freeflow PN 600129 and then foamed by introducing air with the help of a hand-mixing device to a foam litre weight of 300 g/l. 47.5 g of the foamed composition were then poured into a mould made of release paper (VEZ Mat, Sappi, Brussels, Belgium) with dimensions 70×140×10 mm (width×depth×height), where a wet layer thickness of 13 mm was achieved. 14 such casting moulds were then dried in an experimental microwave installation (MWT k/1,2-3 LK reg. from EL-A Verfahrenstechnologie Heidelberg, Germany) for 30 min at 30% power (3.6 kW at maximum power).

The material was then cut into cubes measuring 10×10×10 mm. All sides of the cubes were painted with the coating material prepared in example 2 with the help of a paintbrush and then dried in a convection oven at 130° C. for 30 minutes.

The chewing foams prepared according to the examples were tried out on subjects according to the chewing test described below.

15 subjects with previous dental knowledge were used. The inclusion criterion was a complete dentition without crowning or replacement of the following teeth: 16, 11, 25, 36, 31, 45. Here and also below, the teeth are denoted by reference to the international tooth scheme (FDI two-digit scheme).

The investigation material had the following composition:

30 profile bodies according to example 3, 30 profile bodies according to example 4 and 30 profile bodies according to example 5 (comparative example).

Plaque revealer: Mira-2-Ton®; Hager & Werken GmbH & Co KG; polishing cups: Prophy-Kelche®; Hager & Werken GmbH & Co KG; polishing paste: Miraclean®; Hager & Werken GmbH & Co KG; prophylaxis tray 12 sections University of Witten; photo camera: Nikon D70, lens: Micro Nikkor 105 mm/2.8, Nikon microflash R1; single-ended retractor 2×: Mirahold®; Hager & Werken GmbH & Co KG; lateral mirror: rhodium-coated, Doctorseyes; stopwatch: Samsung SGV—Z140*; laptop: Lenovo, IBM Thinkpad T60.

The investigation method can be described as follows:

1) Calibration:

The subjects' first contact with the product was on day 0. The subjects were calibrated on a chewing time of 30 seconds per jaw quadrant, i.e. to a total chewing time of 120 seconds. A plaque-free oral cavity was achieved by professional tooth cleaning of the investigation regions. The subjects were numbered (numbers 1 to 20). The calibration of the investigator was carried out in such a way that he was instructed how to use the photo camera Nikon D70, the lateral mirror and the retractor.

2) Set-up and Course of the Investigation:

At the start of the investigation, professional tooth cleaning ensured a plaque-free oral cavity for all of the subjects on the teeth to be investigated. In the following 72 hours, the subjects must refrain from any type of oral hygiene. After 72 hours, the plaque was visualized using the plaque revealer Mira-2-Ton® and documented by means of retractor, lateral mirror and photo camera.

In each case, dental photos were made, the image scale for all images being 1:2:

1. Frontal: teeth 11, 16, 25, 45

2. Oral: teeth 11, 31

According to the documentation, the subjects chew the chewing foam according to the previous calibration, i.e. in each case 30 seconds per teeth quadrant.

After the chewing, the plaque was documented again using retractor, lateral mirror and photo camera according to the above scheme.

3) Findings:

Following completion of the investigation, a computer-assisted evaluation of the reduction of the plaque on the smooth and approximal of the vestibular and oral surfaces was carried out. The modified Navy Index using planimetry was used (in accordance with Claydon N., Addy M., Journal of Clinical Periodontology 22 (9), 670-673).

4) Statistical Evaluation:

The evaluation of the investigation results was made using Student's T-test.

5) Results:

The results are listed in table 1 below. For all results where the cleaning effect was significantly different from zero at an error probability of 5%, the table contains an entry in the form of the average percentage cleaning effect for this tooth. The entry “ins” stands for an insignificant test result for this tooth. The percentage fraction of the dental fields which were plaque-coated prior to using the chewing foam and were completely free from plaque following use relative to the total number of plaque-coated dental fields is given. Number of subjects: n=16.

TABLE 1
Percentage cleaning power

| | Example No. | | |
|---|---|---|---|
| | 3 | 4 | 5 (comparison) |
| oral: | | | |
| tooth 11 | 14.66 | 6.23 | 11.63 |
| tooth 31 | 5.94 | 4.72 | ins |
| frontal: | | | |
| tooth 11 | — | 14.95 | 13.88 |
| tooth 16 | — | 11.18 | ins |
| tooth 25 | — | 10.75 | ins |
| tooth 45 | — | 21.85 | ins |

ins: insignificant

As can be seen from table 1, the profile bodies according to the invention as in examples 3 and 4 exhibit an overall greater plaque reduction than a profile body according to comparative example 5.

### EXAMPLE 7

### Dimensional Stability of Foams Essential to the Invention Compared to Polyolefin Foams

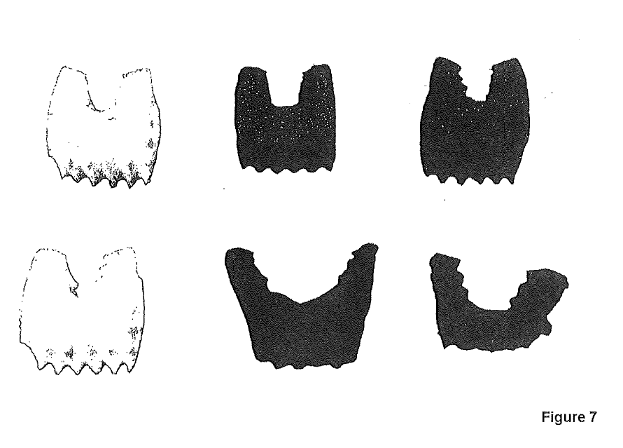

FIG. 7 shows the result of the comparison of the profile bodies according to the invention (profile body top left) with those made of polyolefin foams (profile bodies top centre and top right). Whereas the former are unchanged with regard to their shape even after the chewing process (profile body bottom left), those made of polyolefin foams (Alveolen NA 3611 (centre) and Alveo Soft SA GM2 (right), Sekisui Alveo AG, Lucerne) are clearly deformed (profile bodies bottom centre and bottom right), meaning that effective plaque removal is no longer possible.

1-13. (canceled)

14. A strand-like polymeric foam profile body for tooth cleaning, wherein a cross section of the profile body comprises a floor section and first wall sections and second wall sections, both of which adjoin the floor section and are arranged opposite one another, wherein in the cross section a maximum expanse of the profile body in a direction of the first and second wall section defines a height of the profile body, wherein in the cross section the maximum expanse of the profile body perpendicular to the height defines a width of the profile body and where the floor section together with the first and second wall section forms at least one gap in the profile body to accommodate a tooth, wherein the polymer foam is obtained from a polyurethane-polyurea dispersion (I) which in turn is obtained by preparing
A) isocyanate-functional prepolymers of
a1) organic polyisocyanates
a2) polymeric polyols with number-average molecular weights of ≧400 g/mol to ≦8000 g/mol and OH functionalities of ≧1.5 to ≦6,
B) whose free NCO groups are then completely or partially reacted with
b1) amino-functional compounds with molecular weights of ≧32 g/mol to ≦400 g/mol and/or
b2) amino-functional, ionic or potentially ionic hydrophilizing agents
with chain extension, and the prepolymers are dispersed in water before, during or after step B), where any potentially ionic groups can be converted to the ionic form by partial or complete reaction with a neutralizing agent.

15. The profile body according to claim 14, wherein in cross section, the floor section of the profile body forms elevations on its side facing a gap.

16. The profile body according to claim 15, wherein in cross section, the number of elevations is in a range from ≧2 to ≦10.

17. The profile body according to claim 15, wherein in cross section, a height of the elevations, measured as the distance of the deepest point between two elevations at a right angle to the joining line between two highest points of the elevations directly adjacent to the deepest point, relative to the height of the profile body is in a ratio of from ≧1:15 to ≦1:5.

18. The profile body according to claim 14, wherein in cross section, the floor section of the profile body forms elevations on its side opposite to a gap.

19. The profile body according to claim 14, wherein in cross section, the first wall section and/or the second wall section of the profile body forms elevations on its side facing a gap.

20. The profile body according to claim 19, wherein in cross section, a height of the elevations, measured as distance of the deepest point between two elevations at a right angle to the joining line between two highest points of the elevations directly adjacent to the deepest point, relative to the height of the profile body is in a ratio of from ≧1:30 to ≦1:10.

21. The profile body according to claim 14, wherein in cross section, the maximum expanse of the floor section to the width of the profile body is in a ratio of from ≧1:6 to ≦1:2.

22. The profile body according to claim 14, wherein in cross section, a distance of the deepest point on the side of the floor section facing the gap perpendicular to the joining line between the highest points of the first and second wall sections relative to the height of the profile body is in a ratio of from ≧1:4 to ≦1:1.5.

23. The profile body according to claim 14, wherein the material of the profile body comprises a polymer foam with a tensile modulus at 100% extension of ≧0.3 MPa to ≦3.5 MPa, a tensile strength of ≧0.5 MPa to ≦40 MPa and an extensibility of ≧100% to ≦2000%.

24. The profile body according to claim 14, where, in step A), the isocyanate-functional prepolymers are furthermore prepared from
a3) hydroxy-functional compounds with molecular weights of ≧62 g/mol to ≦399 g/mol and/or
a4) hydroxy-functional, ionic or potentially ionic and/or nonionic hydrophilizing agents.

25. A process for producing a profile body, wherein a cross section of the profile body comprises a floor section and first wall sections and second wall sections, both of which adjoin the floor section and are arranged opposite one another, wherein in the cross section a maximum expanse of the profile body in a direction of the first and second wall section defines a height of the profile body, and wherein in the cross section the maximum expanse of the profile body perpendicular to the height defines a width of the profile body and where the floor section together with the first and second wall section forms at least one gap in the profile body to accommodate a tooth, the method comprising:
applying a foam material prepared from a polyurethane dispersion which in turn is obtained by preparing
A) isocyanate-functional prepolymers of
a1) organic polyisocyanates
a2) polymeric polyols with number-average molecular weights of ≧400 g/mol to ≦8000 g/mol and OH functionalities of ≧1.5 to ≦6,
B) whose free NCO groups are then completely or partially reacted with
b1) amino-functional compounds with molecular weights of ≧32 g/mol to ≦400 g/mol and/or
b2) amino-functional, ionic or potentially ionic hydrophilizing agents
with chain extension, and the prepolymers are dispersed in water before, during or after step B), where any potentially ionic groups can be converted to the ionic form by partial or complete reaction with a neutralizing agent to a flat substrate
foaming and application
curing and/or drying the foam material
shaping the profile body by cutting out or punching out.
